(19) United States
(12) Patent Application Publication
(10) Pub. No.: US 2026/0341718 A1
(43) Pub. Date: Oct. 29, 2026

(54) EVM CATHODE BINDERS FOR BATTERY CELLS USING y-VALEROLACTONE AS PROCESSING SOLVENT

(71) Applicant: ARLANXEO DEUTSCHLAND GMBH, Dormagen (DE)

(72) Inventors: Sven BRANDAU, Leverkusen (DE); Chao LU, Changzhou, Jiangsu (CN); Xiaocai ZHANG, Changzhou, Jiangsu (CN)

(73) Assignee: ARLANXEO DEUTSCHLAND GMBH, Dormagen (DE)

(21) Appl. No.: 19/109,044

(22) PCT Filed: Sep. 4, 2023
(86) PCT No.: PCT/EP2023/074142

§ 371 Date: Mar. 5, 2025

(30) Foreign Application Priority Data
Sep. 6, 2022 (WO) PCT/CN2022/117339

(51) Int. Cl. H01M 4/62; C08F 210/02; C08F 218/08; C09D 5/24; C09D 7/20; C09D 123/08; C09D 131/04

(52) U.S. Cl. CPC H01M 4/622; C08F 210/02; C08F 218/08; C09D 5/24; C09D 7/20; C09D 123/0853; C09D 131/04; C08F 2800/20

(57) ABSTRACT

The invention relates to a polymer comprising or essentially consisting of monomer units derived from ethylene, vinylacetate and optionally, a termonomer selected from glycidyl methacrylate, vinyl methacrylate, and maleic anhydride, wherein the weight content of monomer units derived from vinylacetate is greater than 50 wt.-%, relative to the total weight of the polymer. The polymer is useful for manufacturing a cathode for a battery cell. The invention further relates to a cathode of a battery cell comprising the polymer as well as to a composition comprising the polymer and γ-valerolactone.

### FIELD OF INVENTION

The invention relates to a polymer comprising or essentially consisting of monomer units derived from ethylene, vinylacetate and optionally, a termonomer selected from glycidyl methacrylate, vinyl methacrylate, and maleic anhydride, wherein the weight content of monomer units derived from vinylacetate is greater than 50 wt.-%, relative to the total weight of the polymer. The polymer is useful for manufacturing a cathode for a battery cell. The invention further relates to a preparation of a cathode of a battery cell comprising the polymer as well as to a composition comprising the polymer and γ-valerolactone.

### BACKGROUND OF INVENTION

A rechargeable battery (also known as a storage battery, a secondary cell or an accumulator) is a type of electrical battery which can be charged, discharged and recharged many times. The battery cell comprises electrodes (anode and cathode), a electrolyte and a separator. Within the electrodes, a polymeric binder typically holds active material and conductive material. The binder needs to be flexible and insoluble in the electrolyte. It should provide good adherence to a current collector and have chemical as well as electrochemical stability. Further, it should be applicable to the electrodes in an easy manner.

N-Methylpyrrolidone (NMP) is frequently used as a solvent in the production of cathodes. However, NMP is toxic and there is a demand for non-toxic alternatives in order to allow for safer and greener production of battery cells.

Polyvinylidene fluoride polymer (PVDF) is frequently used as a binder in the production of cathodes. However, PVDF has several drawbacks because the fluorine causes corrosion within the rechargeable battery and is inherently unsafe. As the fluorine can form hydrogen fluoride, handling PVDF requires precautionary safety measures. PVDF has a relatively high density and thus increases the weight of the rechargeable battery.

As a non-toxic and green solvent, γ-valerolactone has been suggested replacing NMP. However, PVDF is barely soluble in γ-valerolactone and additional efforts and elevated temperatures are required to prepare a cathode slurry and electrode. Such solutions of PVDC at high temperatures in γ-valerolactone tend to create gels at room temperature afterwards when the solutions are cooled down.

V. R. Ravikumar et al., ACS Appl. Energy Mater. 2021, 4, 1, 696-703 relates to γ-valerolactone as an alternative solvent for manufacturing of lithium-ion battery electrodes.

JP 2017 045611 A relates to an all-solid type secondary battery that includes an anode active material layer, a solid electrolyte layer and a cathode active material layer in this order. Among many others γ-valerolactone is mentioned as a solvent for the anode active material layer having a boiling point in the range of 180-300 °C.

JP 2018 076417 A relates to a porous membrane, which can be used as a separator and is produced with a porous membrane forming composition containing hydrophobically modified, insulating fibres (A), a binder resin (B), and a solvent (S). Among many others γ-valerolactone is mentioned as a solvent (S).

WO 00 45452 A1 relates to a binder composition for electrode for lithium-ion secondary battery. Among many others γ-valerolactone is mentioned as an organic dispersion medium.

WO 2009 147989 relates to a hydroxyl group-containing resin and an organic acid and/or a derivative thereof in a polar solvent, wherein the hydroxyl group-containing resin is (1) a polyvinyl acetal resin, (2) an ethylene-vinyl alcohol copolymer, (3) an unmodified and/or modified polyvinyl alcohol, (4) a coating liquid characterized by being a polymer having a cyanoethyl group, a coating liquid for electrode plate production, an undercoat agent, and use thereof.

WO 2014 046521 A1 relates to a method of manufacturing a separator for a lithium secondary battery comprising: a step of forming a porous coating layer including inorganic particles on at least one side of a porous substrate; a charging step for forming charged polymer particles by charging polymer particles; a transferring step for transferring the charged polymer particles to an upper surface of the porous coating layer to form a functional coating layer; and a fixing step for fixing the functional coating layer by heat and pressure; a separator manufactured by the method, and a lithium secondary battery including the separator. Among many others γ-valerolactone is mentioned as a nonaqueous electrolyte. WO 2015 073745 A2 relates to a battery that includes a first conductive substrate portion having a first face, and a second conductive substrate portion having a second face opposed to the first face. Among many others γ-valerolactone is mentioned as a solvent that is useful for preparing the cathode.

US 2020 0194837 A1 relates to an additive for a lithium secondary battery. Among many others γ-valerolactone is mentioned as an electrolyte.

US 2022 0037642 relates to thick positive electrodes (e.g., cathodes) for an electrochemical cell that cycles lithium and methods for making them. A slurry may be applied to a current collector or other substrate. The slurry includes positive electroactive material particles, graphene nanoplatelets, polymeric binder, and solvent and has a solids content of ≥about 65% by weight and a kinematic viscosity of greater than or equal to about 6 Pa·s to less than or equal to about 30 Pa·s at a shear rate of about 20/s.

EP 3 605 675 A1 discloses a polymer and its use as a binder. The polymer contains a conjugated diene monomer unit and/or an alkylene structural unit and a nitrile group-containing monomer unit and optionally other repeating units (e.g. (meth)acrylic acid ester monomers, such as n-butyl acrylate). The polymer is used with PVDF.

There is a need for polymers that can be used as cathode binders and that have advantages compared to the polymers of the prior art.

It is an object of the invention to provide battery cells and cathodes thereof that have advantages compared to the prior art, especially with regard to safety and environmental issues. The polymers should overcome the drawbacks of PVDF and should be compatible with safer and greener solvents, especially γ-valerolactone, in order to overcome the drawbacks of NMP.

### SUMMARY OF INVENTION

This object has been achieved by the subject-matter of the patent claims.

The invention relates to a composition containing a polymer comprising or essentially consisting of monomer units derived from ethylene, vinylacetate and optionally, a termonomer selected from glycidyl methacrylate, vinyl methacrylate, and maleic anhydride, wherein the weight content of monomer units derived from vinylacetate is greater than 50 wt.-%, relative to the total weight of the polymer. Thus, the polymer according to the invention may be regarded as an EVM copolymer optionally additionally comprising monomer units derived from a termonomer (terpolymer). In view of the comparatively high content of monomer units derived from vinylacetate, the polymer typically is a thermoplastic elastomer.

It has been surprisingly found that such polymer has a high electrochemical stability and can be readily dissolved in the non-toxic and green solvent γ-valerolactone at room temperature. Those binder solutions can be further processed at room temperature to obtain cathode slurries and cathodes which show very good electrochemical performance and stability. Preferably, the slurries are LFP based or NMC based.

The polymer provides an at least suitable alternative to the cathode binders of the prior art whilst overcoming the need to use polyvinylidene fluoride (PVDF) and N-methyl pyrrolidone (NMP).

The polymer and a cathode binder made from the polymer is free of PVDF thereby overcoming safety issues and issues with respect to corrosion during manufacture and use in battery applications.

The polymer exhibits at least the same or superior binder properties compared to conventional cathode binders based on PDVF.

The polymer has a lower density compared to PDVF and due to its reduced weight is favourable in portable devices or electric vehicles using a rechargeable battery.

When used as a cathode binder, the polymer maintains capacity retention after being charged, discharged and recharged.

The polymer can be advantageously processed with γ-valerolactone as a solvent in the manufacture of cathodes for battery cells thereby avoiding the need of NMP. Binder solutions of polymer in γ-valerolactone can be prepared at room temperature allowing for smooth processing and preparation of electrodes. Electrochemical evaluation of the cathodes shows a high capacity and stability.

### DETAILED DESCRIPTION

For a complete understanding of the present invention and the advantages thereof, reference is made to the following detailed description. It should be appreciated that the various aspects and embodiments of the detailed description as disclosed herein are illustrative of the specific ways to make and use the invention and do not limit the scope of invention when taken into consideration with the claims and the detailed description. It will also be appreciated that features from different aspects and embodiments of the invention may be combined with features from different aspects and embodiments of the invention.

The polymer of the composition according to the invention comprises or essentially consists of monomer units derived from ethylene, vinylacetate and optionally, a termonomer selected from glycidyl methacrylate, vinyl methacrylate, and maleic anhydride, wherein the weight content of monomer units derived from vinylacetate is greater than 50 wt.-%, relative to the total weight of the polymer.

It has been surprisingly found that a certain content of polar monomers including vinylacetate and optionally a termonomer selected from glycidyl methacrylate, vinyl methacrylate, and maleic anhydride, provides good solubility in γ-valerolactone as well as performance as binder in electrodes.

The term “monomer units” means that a structural unit derived from that monomer is incorporated in the polymer backbone which is obtained by polymerizing that monomer. A skilled person recognizes that polymerization changes the monomer structure and such change is expressed by the term “derived from”.

Preferably, the polymer has a weight content of monomer units derived from vinylacetate is within the range of 55 to 95 wt.-%, preferably 55 to 85 wt.-%, more preferably 55 to 75 wt.-%, still more preferably 55 to 65 wt.-%, relative to the total weight of the polymer.

Preferably, the polymer has a weight content of monomer units derived from ethylene is greater than 10 wt.-% and below 50 wt.-%, relative to the total weight of the polymer. Preferably, the polymer has a weight content of monomer units derived from ethylene is within the range of 35 to 45 wt.-%, relative to the total weight of the polymer.

Preferably, relative to the total weight of the polymer, the polymer has a weight content of monomer units derived from vinylacetate within the range of from 55 to 65 wt.-%; and a weight content of monomer units derived from ethylene within the range of from 35 to 45 wt.-%.

In preferred embodiments, the polymer does not comprise monomer units derived from a termonomer selected from glycidyl methacrylate, vinyl methacrylate, and maleic anhydride. Preferably, the polymer essentially consists of monomer units derived from vinylacetate and ethylene (copolymer, bipolymer).

In other preferred embodiments, the polymer additionally comprises monomer units derived from a termonomer selected from glycidyl methacrylate, vinyl methacrylate, and maleic anhydride; preferably glycidyl methacrylate. Preferably, the polymer essentially consists of monomer units derived from vinylacetate, ethylene, and a termonomer selected from glycidyl methacrylate, vinyl methacrylate, and maleic anhydride; preferably glycidyl methacrylate (terpolymer).

Preferably, the polymer has a weight content of monomer units derived from the termonomer selected from glycidyl methacrylate, vinyl methacrylate, and maleic anhydride of at least 0.1 wt.-%, relative to the total weight of the polymer. Preferably, the polymer has a weight content of monomer units derived from the termonomer selected from glycidyl methacrylate, vinyl methacrylate, and maleic anhydride within the range of from 0.1 to 10.0 wt.-%, particularly from 0.1 to 5.0 wt.-% relative to the total weight of the polymer.

Preferably, relative to the total weight of the polymer, the polymer has a weight content of monomer units derived from vinylacetate within the range of from 55 to 65 wt.-%; a weight content of monomer units derived from ethylene within the range of from 35 to 45 wt.-%; and a weight content of monomer units derived from the termonomer selected from glycidyl methacrylate, vinyl methacrylate, and maleic anhydride within the range of from 0.1 to 10.0 wt.-%, particularly from 0.1 to 5.0 wt.-%.

Preferably, the termonomer is glycidyl methacrylate

Preferably, the polymer has a Mooney viscosity (ML 1+4 @100 °C) within the range of from 15 to 45 MU.

In a preferred embodiment, the polymer essentially consists of monomer units derived from the following monomers at the following contents, relative to the total weight of the polymer: vinylacetate 60±2 wt.-% and ethylene 40±2 wt.-% (see example E below).

In a preferred embodiment, the polymer essentially consists of monomer units derived from the following monomers at the following contents, relative to the total weight of the polymer: vinylacetate 70±2 wt.-% and ethylene 30±2 wt.-% (see example F below).

In a preferred embodiment, the polymer essentially consists of monomer units derived from the following monomers at the following contents, relative to the total weight of the polymer: vinylacetate 90±2 wt.-% and ethylene 10±2 wt.-% (see example G below).

In a preferred embodiment, the polymer essentially consists of monomer units derived from the following monomers at the following contents, relative to the total weight of the polymer: vinylacetate 60±2 wt.-%, ethylene 37±2 wt.-%, and glycidyl methacrylate 3±2 wt.-% (see example H below).

In a preferred embodiment, the polymer essentially consists of monomer units derived from the following monomers at the following contents, relative to the total weight of the polymer: vinylacetate 59.5±2 wt.-%, ethylene 40±2 wt.-%, and vinyl methacrylate 0.5±0.4 wt.-% (see example I below).

The polymer according to the invention is related to different aspects of the invention.

Preferably, the polymer has a density within the range of 1.04±0.02 g/cm³. Preferably, the polymer has a Mooney viscosity ML(1+4) at 100 °C within the range of 25±5 MU.

A method for the manufacture of the polymer is not limited and the method can be according to methods known in the art. The method for the manufacture of the polymer can be any of solution polymerisation, suspension polymerisation, bulk polymerisation and emulsion polymerisation. The method for the manufacture of the polymer may be addition polymerisation, such as ionic polymerisation, radical polymerisation and living radical polymerisation.

When the polymer is used as cathode binder for a rechargeable battery, the binder holds active material and conductive material within a cathode of the rechargeable battery. The polymer is then dissolved and/or dispersed in an organic solvent to form a binder solution, whereas γ-valerolactone is preferably used as solvent.

The polymer can be ground prior to being dissolved and/or dispersed using a ball mill, a sand mill, a bead mill, a pigment disperser, a grinding machine, an ultrasonic disperser, a homogeniser, a planetary mixer. Such devices can also be used to facilitate the dissolving and and/or dispersing the polymer in the organic solvent to form the binder solution.

The binder solution is then preferably mixed with active material and conductive material to form a cathode slurry composition.

The active material can be a lithium nickel manganese cobalt oxide (abbreviated as Li-NMC, LNMC, NMC or NCM), which is a mixed metal oxides of lithium, nickel, manganese and cobalt. The active material can be a lithium iron phosphate (LFP). The active material can be a lithium manganese oxide (LMO). Lithium iron phosphate (LFP) is preferred.

The conductive material can be carbon materials such as carbon black (e.g. acetylene black, furnace black), graphite (graphene), carbon fibres (carbon nanofibres, multi- or single wall carbon nanotubes (CNTs) and vapour-grown carbon fibres) and carbon flakes.

The cathode slurry composition is then preferably applied to a current collector and then dried.

The application to the current collector can be by doctor blading, dip coating, reverse roll coating, direct roll coating, gravure coating, extrusion coating, bar coater and brush coating. A thickness of the cathode slurry composition on the current collector after application but before drying may be set as appropriately.

The current collector is a material having electrical conductivity and electrochemical durability. The current collector can be made of iron, copper, aluminium, nickel, stainless steel, titanium, tantalum, gold or platinum. The current collector can be in the form of a foil. The current collector is preferably aluminium foil due to its high conductivity, electrochemical and chemical stability and low cost.

Drying of the cathode slurry composition applied to at least one surface of a current collector is preferably achieved by warm, hot, or low humidity air at ambient pressure; drying in a vacuum, drying by irradiation with infrared light or drying with electron beams can also be used.

Following drying, the cathode slurry composition applied to the current collector may be pressed, by mould pressing or roll pressing. The pressing provides a more uniform layer of the dried material.

The resultant positive cathode, comprising the polymer as positive cathode binder is then assembled to form the rechargeable battery.

The rechargeable battery is assembled, preferably by stacking the positive cathode and a negative electrode with a separator in-between, rolling or folding the resultant stack can be necessary in accordance with a shape of the rechargeable battery to place the stack in a battery vessel, filling the battery vessel with an electrolytic solution and then sealing the battery vessel.

In order to prevent pressure increase inside the rechargeable battery and occurrence of over-charging or over-discharging, an overcurrent preventing device such as a PTC device or a fuse; an expanded metal (such as a nickel sponge); or a lead plate can be provided as necessary.

The shape of the rechargeable battery may for example be a coin type, button type, sheet type, cylinder type, prismatic type or flat type.

The negative electrode may be any known negative electrode, for example carbon materials such as amorphous carbon, natural graphite, artificial graphite, natural black lead, mesocarbon microbead pitch-based carbon fibre and silicon-graphite; a conductive polymer such as polyacene or polyaniline; or a metal such as silicon, tin, titanium oxide, zinc, manganese, iron, lithium (for half cells) and nickel including an alloy of the metal. The negative electrode is preferably graphite or silicon-graphite.

The separator can be a fine porous membrane or a nonwoven fabric comprising polyamide resins. The fine porous membrane can be made of a polyolefin resin (polyethylene, polypropylene, polybutene, or polyvinyl chloride). The polyolefin resin is preferred since such a separator membrane can reduce a total thickness of the separator, which increases the ratio of the active material and conductive material in the rechargeable battery and ultimately a size of the rechargeable battery.

The electrolytic solution is a solution of supporting electrolyte that is dissolved in an organic solvent.

The supporting electrolyte is a lithium salt, such as LiPF₆, LiAsF₆, LiBF₄, LiSbF₆, LiAlCl₄, LiClO₄, CF₃SO₃Li, C₄F₉SO₃Li, CF₃COOLi, (CF₃CO)₂NLi, (CF₃SO₂)₂NLi and (C₂F₅SO₂)NLi. LiPF6 is preferable as it readily dissolves in a solvent and exhibits a high degree of dissociation. The organic solvent can carbonates such as dimethyl carbonate (DMC), ethylene carbonate (EC), fluoroethylene carbonate (FEC), diethyl carbonate (DEC), propylene carbonate (PC), butylene carbonate (BC), and methyl ethyl carbonate (EMC); esters such as γ-butyrolactone and methyl formate; ethers such as 1,2-dimethoxyethane and tetrahydrofuran; and sulphur-containing compounds such as sulfolane and dimethyl sulfoxide.

### EXAMPLES

The present invention is demonstrated by the following non-limiting examples.

The following materials where used as provided:

Monomer units ethylene (E), vinyl acetate (VA), glycidyl methacrylate (GMA), maleic anhydride (MAH) and vinyl methacrylate (VMA) from Sigma-Aldrich.

γ-Valerolactone (GVL) from Sigma-Aldrich.

Solef® 5130 as polyvinylidene fluoride resin with a molecular weight of 1300 kDa (copolymer B)

Kynar® HSV 900 as polyvinylidene fluoride resin with melt viscosity (230 °C, 100 s⁻¹) of 48-52.5 kPoise (copolymer A)

Keltan® 1519R as ethylene-based copolymer J

Lithium iron phosphate: active material; A8-4E, from Hubei Wanrun New Energy Technology Co., LTD.

Lithium-Nickel-Mangan-Cobalt-Oxide: active material; NMC 811, SX806D, from Jiangsu Xiangying Amperex Technology Limited.

Conductive carbon black: conductive material; Super C65; from Imerys Graphite & Carbon.

Carbon coated aluminium foil: current collector; thickness 14 μm; from Guangzhou Nano New Material Technology Company Ltd.

Lithium disc: anode; 0 16 mm from China Energy Lithium Co., Ltd.

Porous polyolefin film: as separator, thickness 25 μm (Celgard® 2400), punched into 0 18 mm disc; from Celgard.

Electrolytic solution supporting electrolyte LiPF₆ (Zhuhai Guangrui New Materials Co., Ltd.). Electrolytic solution: 1M in EC/EMC mixture, EC/EMC=30/70 (v/v) with 2 wt % VC. Ethylene carbonate (EC), ethyl methyl carbonate (EMC) and vinylene carbonate (VC): organic solvent used for the electrolytic solution.

Battery vessel: coin cell: casing; 2032 type from Shanxi Lizhiyuan Battery Material Co.

Support in coin cell: stainless steel spacer: 4 16.2 mm*1.0 mm, stainless steel spring: φ 15.4 mm*1.1 mm.

3M tape: vinyl electrical tape (width of 17.5 mm) from 3M China Company.

### Test Methods

### Solubility

The samples were dissolved according to the following procedure, and their solubility evaluated using the succeeding criteria.

A sample was placed at given concentration in the given solvent and shaken at room temperature at 150 rpm using a IKA shaker KS 4000i control. After a given time the samples were subjected to visual assessment.
−− Sample is not dissolved
− Sample starts to be dissolved, swollen particles and most of sample remaining undissolved
0 Sample starts to be dissolved, particles remaining undissolved
+ Most of sample is dissolved, small residuals or partial cloudiness
++ Sample is fully dissolved and do not show any residuals

### Mooney Viscosity

The values of the Mooney viscosity (ML 1+4@100 °C) were determined in each case by means of a shearing disc viscometer to DIN 53523/3 or ASTM D 1646 at 100 °C.

### Method of Evaluating Slurry and Electrode Appearance

The evaluation of slurry and electrode appearance was subjected to visual assessment, and evaluated using the following criteria:

### Slurry

++ Slurry is liquid and free-flowing and do not has any particles
+ Slurry is liquid and free-flowing but show small or fine particles
0 Slurry is pasty and not free flowing, showing undispersed larger particles
+ Slurry is not liquid and homogenous but ingredients show first mixing
++ Slurry is not liquid and homogenous ingredients do not show any miscibility and phase separation

### Electrode:

++ Homogeneous electrode without any particles or defects
+ Homogeneous electrode with limited amount of small undispersed particles or defects
0 Electrode is not homogeneous and showing major defects
− Electrode can only be partly prepared, and showing more voids
−− No coating possible, slurry can't be processed

### NMR

The microstructure and the termonomer content of the individual polymers were determined by means of ¹H NMR (instrument: Bruker DPX400 with XWIN-NMR 3.1 software, measurement frequency 400 MHz, solvent CDCl₃).

### Method of Evaluating Discharging Specific Capacity

The produced secondary battery was charged at 0.1 C rate at 23 °C until the battery voltage reached 4.2 V (for NMC) or 4.0 V (for LFP). Subsequently after 20 minutes, at 23 °C, a constant current discharge was performed at 0.1 C rate until the battery voltage reached 3.0 V (for NMC) or 2.8 V (for LFP). The coin cell secondary battery was charged and discharged thereafter in constant current mode (CC mode 0.5 C rate). Between every cycle, there the cell was rested for 5 min. The discharging specific capacity of the secondary battery was calculated as the average value between 2 and 5 cycles.

### Method of Evaluating Capacity Retention

The coin cell secondary battery was charged and discharged in constant current mode (CC mode 0.2 C rate) for 50 cycles. Capacity retention was determined as the ratio of the discharge specific capacity after 50 cycles over the discharge specific capacity after the second cycle in percent. Then, the capacity retention was calculated and evaluated based on the following criteria.
++ Capacity retention is 95% or more
+ Capacity retention is 85% or more and less than 95%
0 Capacity retention is 75% or more and less than 85%
− Capacity retention is less than 75%

### Preparation of Modified Ethylene-Vinyl Acetate Copolymers

Modified ethylene-vinyl acetate copolymers were prepared according the following procedure (Examples E, F, G, H and I are according to the invention, Examples A-D and J are comparative):

The preparation was carried out in a 5 L stirred autoclave. For this purpose, a monomer solution according table 1 consisting of tert-butanol, vinyl acetate (VA), glycidyl methacrylate (GMA) or vinyl methacrylate (VMA) together with 252.5 g of an activator solution consisting of 2.5 g of ADVN and 250 g of vinyl acetate/tert-butanol solution (vinyl acetate 20%) were drawn one after another into the 5 L reactor at RT.

TABLE 1
Components used for the manufacture
of ethylene-based rubbers C to I:

| Copolymer | C | D | E | F | G | H | I |
|---|---|---|---|---|---|---|---|
| tert-butanol [g] | 1023 | 785 | 693 | 763 | 955 | 693 | 693 |
| Ethylene [g] | 1122 | 1182 | 1090 | 832 | 180 | 1062 | 1062 |
| Vinyl acetate [g] | 610 | 935 | 1288 | 1738 | 2095 | 1288 | 1288 |
| GMA [g] | 0 | 0 | 0 | 0 | 0 | 2 | 0 |
| VMA [g] | 0 | 0 | 0 | 0 | 0 | 0 | 1 |

The reactor was inertized with nitrogen and then 1062 g of ethylene (E) were injected. The temperature was raised to 61 °C, establishing a pressure of approximately 380 bar. After half an hour, at which point the conversion was about 10 wt.-%, based on the vinyl acetate (VA), a solution consisting of 122.2 g of tert-butanol, 143.8 g of vinyl acetate (VA) and for copolymer H 40.0 g of glycidyl methacrylate (GMA) was metered into the reaction mixture at a rate of 0.6 g/min. Throughout the whole reaction period, the pressure was maintained at ca, 380 bar by injection of ethylene (E). After a reaction time of 10 hours, the metering of ethylene (E) was concluded and the polymer solution was expressed from the 5 L reactor into a stopping autoclave. After removal of the solvent and the residual monomers modified ethylene-vinyl acetate copolymers were obtained.

TABLE 2
Properties of polyvinylidene fluoride resins (A and B) and of ethylene-based rubbers (C to J):

| Copolymer | A | B | C | D | E | F | G | H | I | J |
|---|---|---|---|---|---|---|---|---|---|---|
| E [wt.-%] | 0 | 0 | 60 | 50 | 40 | 30 | 10 | 37 | 40 | 49 |
| VA [wt.-%] | 0 | 0 | 40 | 50 | 60 | 70 | 90 | 60 | 59.5 | 0 |
| GMA [wt.-%] | 0 | 0 | 0 | 0 | 0 | 0 | 0 | 3 | 0 | 0 |
| VMA [wt.-%] | 0 | 0 | 0 | 0 | 0 | 0 | 0 | 0 | 0.5 | 0 |
| MAH [wt.-%] | 0 | 0 | 0 | 0 | 0 | 0 | 0 | 0 | 0 | 1.9 |
| polar monomers [wt.-%] | 0 | 0 | 40 | 50 | 60 | 70 | 90 | 63 | 60 | 1.9 |
| Mooney Viscosity ML(1 + 4) | ^{a)} | ^{b)} | 20 | 27 | 27 | 27 | 38 | 20 | 40 | <10 |
| 100 °C, (MU) | | | | | | | | | | |
| Density [g/cm³] | 1.78 | 1.77 | 0.98 | 1.00 | 1.04 | 1.07 | 1.15 | 1.04 | 1.03 | 0.86 |

^{a)} Molecular weight: about 1000 kDa;
^{b)} Molecular weight: 1300 kDa;

The results from Table 2 show that the polymers according to the invention maintain at least a lower density and thus that of ensuing electrodes compared to PVDF being halogen free.

Different inventive and comparative samples were dissolved in γ-valerolactone at room temperature and their solubility was evaluated after 24 hours. It can be noticed that all polyvinylidene fluoride resins do not dissolve in γ-valerolactone at room temperature at all while inventive ethylene based rubbers dissolve already at room temperature well in γ-valerolactone, leading to an improvement in battery cell productivity and energy savings in the preparation process. Moreover it can be noted that the solubility performance is independent of incorporated polar monomers.

TABLE 3
Solubility of ethylene based rubbers and polyvinylidene fluoride

| Polymer | A | B | C | D | E | F | G | H | I | J |
|---|---|---|---|---|---|---|---|---|---|---|
| Solvent | GVL | GVL | GVL | GVL | GVL | GVL | GVL | GVL | GVL | GVL |
| Concentration | 5% | 5% | 5% | 5% | 5% | 5% | 5% | 5% | 5% | 5% |
| Solubility rating [24 h] | −− | −− | − | 0 | ++ | ++ | ++ | ++ | ++ | − |

The results in Table 3 show that ethylene based rubbers with a minimum amount of polar monomers have a good solubility in γ-valerolactone at room temperature, while polyvinylidene fluoride resins or polymers with low amount of polar monomers can not be dissolved at all or are just swollen in γ-valerolactone. The preparation of a binder solution at room temperature using the non-toxic solvent γ-valerolactone can be therefore managed using the inventive ethylene-based rubbers, replacing toxic battery solvent NMP.

### General Method of Coin Cell Fabrication

Step (1)—Dissolution: A certain amount of the polymer is dissolved in the solvent (γ-valerolactone) in a shaker overnight at room temperature to form a binder solution (8 wt.-%).

Step (2a)—NMC811 cathode slurry composition preparation: The binder solution from step 1 is mixed with the conductive material (conductive carbon black Super C65) in a thinky mixer (milling conditions: 2000 rpm, 12 minutes, room temperature). Thereafter the active material NMC811 and remaining solvent (γ-valerolactone) is added (milling conditions: 2000 rpm, 18 minutes, room temperature) to obtain the cathode slurry composition.

TABLE 4
Formulation of NMC811 based battery cell

| Formulation | Weight ratio (%) |
|---|---|
| Binder solution in y-valerolactone, 8 wt.- % | 18.8 |
| Conductive carbon black (Super C65) | 1.5 |
| Active material (NMC811) | 97.0 |
| γ-valerolactone (remaining solvent) | 16.1 |

Weight ratio: NMC811/polymer/γ-valerolactone/Super C65 = 97,0/1,5/33,5/1,5 (Polymer concentration in γ-valerolactone = 8 wt.-%) for a total slurry solid content as stated

Step (2b)—UFP cathode slurry composition preparation: The binder solution from step 1 is mixed with the conductive material (conductive carbon black Super C65) in a thinky mixer (milling conditions: 2000 rpm. 12 minutes, room temperature). Thereafter the active material (LFP, C-coated, A8-4E) and half solvent (γ-valerolactone) is added (milling conditions: 2000 rpm. 18 minutes, room temperature), finally the remaining solvent (γ-valerolactone) is added (milling conditions: 2000 rpm. 6 minutes, room temperature) to obtain the cathode slurry composition.

TABLE 5
Formulation of LFP based battery cell

| Formulation | Weight ratio (%) |
|---|---|
| Binder solution in y-valerolactone, 8 wt.- % | 25 |
| Conductive carbon black (Super C65) | 2 |
| Active material (LFP) | 96 |
| γ-valerolactone (remaining solvent) | 44 |

Weight ratio: LFP/polymer/γ-valerolactone/Super C65 = 96/2/67/2 (Polymer concentration in γ-valerolactone = 8 wt.- %) for a total slurry solid content as stated

Step (3)—Production of the cathode disc: The cathode slurry composition was applied with a bar coater onto a current collector (aluminum foil) using 4.1 mm/s coating speed to form a cathode sheet. The coater slit gap of the coating machine was adjusted to 250 μm to obtain a pre-determined coating thickness.

Step (4)—Drying: The cathode sheet was dried in an oven at 120 °C for 240 minutes to remove solvent and moisture. After drying the cathode sheet was compressed with a hot press first and then calandered with a 2-roll device until dried thickness is reduced by 20% and to adjust the areal density. From the calandered cathode sheet acathode disc (0 16 mm) was punched using a machine from Shenzhen Poxon Machinery Technology Co., Ltd. Model: PX-CP-S2. The punch edge was sharp without burr.

Step (5)—Assembly of the lithium-ion secondary battery: Assembly and pressing of the lithium-ion secondary battery is carried out in a glove box. The assembly comprises the coin ccli casing top (2032 type; negative side), support (stainless steel spacer×2 & spring), the lithium disc (as anode), the porous separator (Celgard 2400), the cathode disc and the casing bottom (positive side). All parts were assembled layer-by-layer. The electrolyte solution (140 L 1M/L LiPF6 in EC/EMC=30/70 (v/v) with 2 wt % VC) was dropped in during the assembly step in order to completely fill the free volume of the coin cell. Finally, the coin cell case was pressed by the press machine in the glovebox. An open-circuit voltage test was performed to check, whether short-circuit took place or not.

TABLE 6
Determination of the discharging specific capacity and the capacity retention
of the NMC 811 lithium-ion battery (examples A, B, D, E, H and J)

| Copolymer | A | B | D | E | H | J |
|---|---|---|---|---|---|---|
| Active material | NMC811 | NMC811 | NMC811 | NMC811 | NMC811 | NMC811 |
| Solid content [%] | 60 | 60 | 60 | 75 | 75 | 60 |
| Slurry quality | −− | −− | −− | ++ | ++ | −− |
| Electrode quality | −− | −− | −− | ++ | ++ | −− |

TABLE 7
Determination of the discharging specific capacity and the capacity retention
of the LFP based lithium-ion battery (examples A-E, H and J)

| Copolymer | A | B | C | D | E | H | J |
|---|---|---|---|---|---|---|---|
| Active material | LFP | LFP | LFP | LFP | LFP | LFP | LFP |
| Solid content [%] | 60 | 60 | 60 | 60 | 75 | 75 | 60 |
| Slurry quality | −− | −− | − | 0 | ++ | ++ | − |
| Electrode quality | −− | −− | −− | −− | ++ | ++ | −− |
| Discharging specific capacity [mAh/g] | np^{a)} | np^{a)} | np^{a)} | np^{a)} | 141 | 138 | np^{a)} |
| Capacity retention after 50 cycles | np | np | np | np | ++ | ++ | np |

^{a)} np: not possible to determine as no electrodes can be prepared based on the non- or bad solubility of polymers in γ-valerolactone even at lower solids

The results in Tables 6 and 7 show that the use of fluorine-free ethylene-based rubbers with a specific polarity (examples E and H) lead to a high specific capacity maintaining a good capacity retention using a non-toxic solvent for battery processing. It is therefore possible to replace the toxic battery solvent NMP and by using the inventive ethylene-based rubbers to obtain battery cells with a high capacity and capacity retention.

Having thus described the present invention and the advantages thereof, it should be appreciated that the various aspects and embodiments of the present invention as disclosed herein are merely illustrative of specific ways to make and use the invention.

The various aspects and embodiments of the present invention do not limit the scope of the invention when taken into consideration with the appended claims and the foregoing detailed description.

What is desired to be protected by letters patent is set forth in the following claims.

1. A composition comprising:
(i) a polymer comprising or essentially consisting of monomer units derived from:
ethylene;
vinylacetate; and
optionally, a termonomer selected from glycidyl methacrylate, vinyl methacrylate, and maleic anhydride;
wherein a weight content of monomer units derived from vinylacetate is greater than 50 wt.-%, relative to a total weight of the polymer; and
(ii) γ-valerolactone.

2. A composition according to claim 1, wherein the weight content of monomer units derived from vinylacetate is within the range from 55 to 95 wt.-%, relative to the total weight of the polymer.

3. A composition according to claim 1, wherein a weight content of monomer units derived from ethylene is greater than 30 wt.-% and below 50 wt.-%, relative to the total weight of the polymer.

4. A composition according to claim 1, wherein a weight content of monomer units derived from ethylene is within the range of 35 to 45 wt.-%, relative to the total weight of the polymer.

5. A composition according to claim 1, wherein relative to the total weight of the polymer, the polymer has:
a weight content of monomer units derived from vinylacetate within the range of from 55 to 65 wt.-%; and
a weight content of monomer units derived from ethylene within the range of from 35 to 45 wt.-%.

6. A composition according to claim 1, wherein the polymer does not comprise monomer units derived from a termonomer selected from glycidyl methacrylate, vinyl methacrylate, and maleic anhydride.

7. A composition according to claim 1, wherein the polymer has a weight content of monomer units derived from the termonomer selected from glycidyl methacrylate, vinyl methacrylate, and maleic anhydride of at least 0.1 wt.-%, relative to the total weight of the polymer.

8. A composition according to claim 7, wherein the polymer has a weight content of monomer units derived from the termonomer selected from glycidyl methacrylate, vinyl methacrylate, and maleic anhydride within the range of from 0.1 to 10.0 wt.-%, relative to the total weight of the polymer.

9. A composition according to claim 7, wherein relative to the total weight of the polymer, the polymer has:
a weight content of monomer units derived from vinylacetate within the range of from 55 to 65 wt.-%;
a weight content of monomer units derived from ethylene within the range of from 35 to 45 wt.-%; and
a weight content of monomer units derived from the termonomer selected from glycidyl methacrylate, vinyl methacrylate, and maleic anhydride within the range of from 0.1 to 5.0 wt.-%.

10. A composition according to claim 7, wherein the termonomer is glycidyl methacrylate.

11. A composition according to claim 1, the polymer essentially consists of monomer units derived from the following monomers at the following contents, relative to the total weight of the polymer:
(i) vinylacetate 60±2 wt.-% and ethylene 40±2 wt.-%;
(ii) vinylacetate 70±2 wt.-% and ethylene 30±2 wt.-%;
(iii) vinylacetate 80±2 wt.-% and ethylene 20±2 wt.-%;
(iv) vinylacetate 90±2 wt.-% and ethylene 10±2 wt.-%;
(v) vinylacetate 60±2 wt. %, ethylene 37±2 wt.-%, and glycidyl methacrylate 3±2 wt.-%; or
(vi) vinylacetate 59.5±2 wt.-%, ethylene 40±2 wt.-%, and vinyl methacrylate 0.5±0.4 wt.-%.

12. Cathode of a battery cell obtained from a composition according to claim 1.

13. A rechargeable battery comprising a battery cell comprising a cathode according to claim 12.

14. A battery-powered device comprising the rechargeable battery according to claim 14.
